(19) United States
(12) Patent Application Publication
(10) Pub. No.: US 2017/0043907 A1
(43) Pub. Date: Feb. 16, 2017

(54) Compartmentalized Food Container Device

(71) Applicant: Darla Drendel, Glendora, CA (US)

(72) Inventor: Darla Drendel, Glendora, CA (US)

(21) Appl. No.: 14/826,898

(22) Filed: Aug. 14, 2015

(51) Int. Cl. B65D 25/04; B65D 81/34; B65D 43/14; A47J 47/02; B65D 47/32

(52) U.S. Cl. CPC B65D 25/04; A47J 47/02; B65D 47/32; B65D 43/14; B65D 81/3453; B65D 2543/00833

(57) ABSTRACT

A compartmentalized food container device for compartmentalizing food for storage, freezing, and microwaving includes a plurality of bins, each having a bottom and an open top, and a lid that is complimentary to the open top. A vent having a seal that is removable is positioned in the lid. A plurality of couplers is coupled to a border of the lid. Each of a plurality of first fasteners is coupled to an outside surface of the bin. A plurality of second fasteners, which is complimentary to both the plurality of first fasteners and the plurality of couplers, is coupled to the outside surface. A plurality of dividers is coupled to the bottom and extends between an opposing pair of sidewalls. A plurality of holes is positioned in the bottom of a plurality of intermediate bins. The device is microwavable.

### BACKGROUND OF THE DISCLOSURE

### Field of the Disclosure

The disclosure relates to container devices and more particularly pertains to a new container device for compartmentalizing food for storage, freezing, and microwaving.

### SUMMARY OF THE DISCLOSURE

An embodiment of the disclosure meets the needs presented above by generally comprising a plurality of bins, each having a bottom and an open top, and a lid that is complimentary to the open top. A vent having a seal that is removable is positioned in the lid. A plurality of couplers is coupled to a border of the lid. Each of a plurality of first fasteners is coupled to an outside surface of the bin. A plurality of second fasteners, which is complimentary to both the plurality of first fasteners and the plurality of couplers, is coupled to the outside surface. A plurality of dividers is coupled to the bottom and extends between an opposing pair of sidewalls. A plurality of holes is positioned in the bottom of a plurality of intermediate bins. The device is microwavable.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a compartmentalized food container device according to an embodiment of the disclosure.

FIG. 2 is an exploded view of an embodiment of the disclosure.

FIG. 3 is a side view of an embodiment of the disclosure.

FIG. 4 is a cross-sectional view of an embodiment of the disclosure.

FIG. 5 is a top view of an embodiment of the disclosure.

### DESCRIPTION OF THE PREFERRED EMBODIMENT

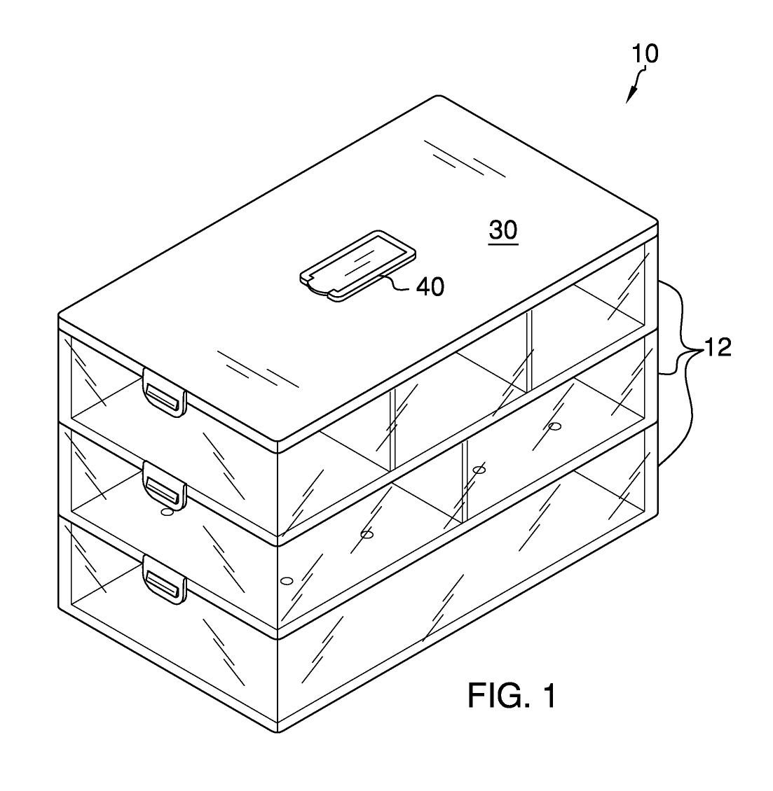

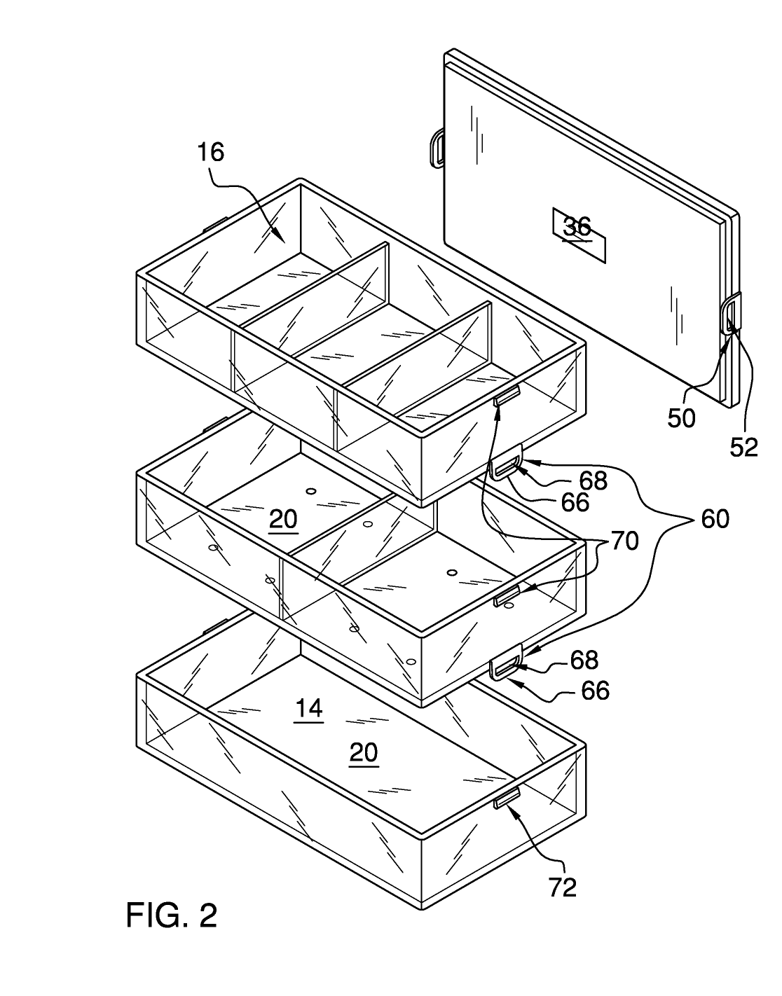

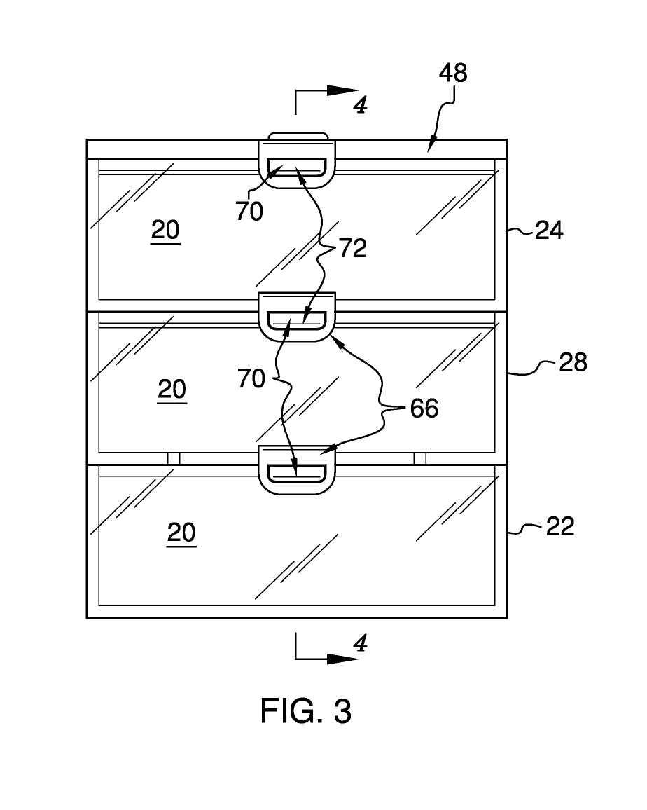

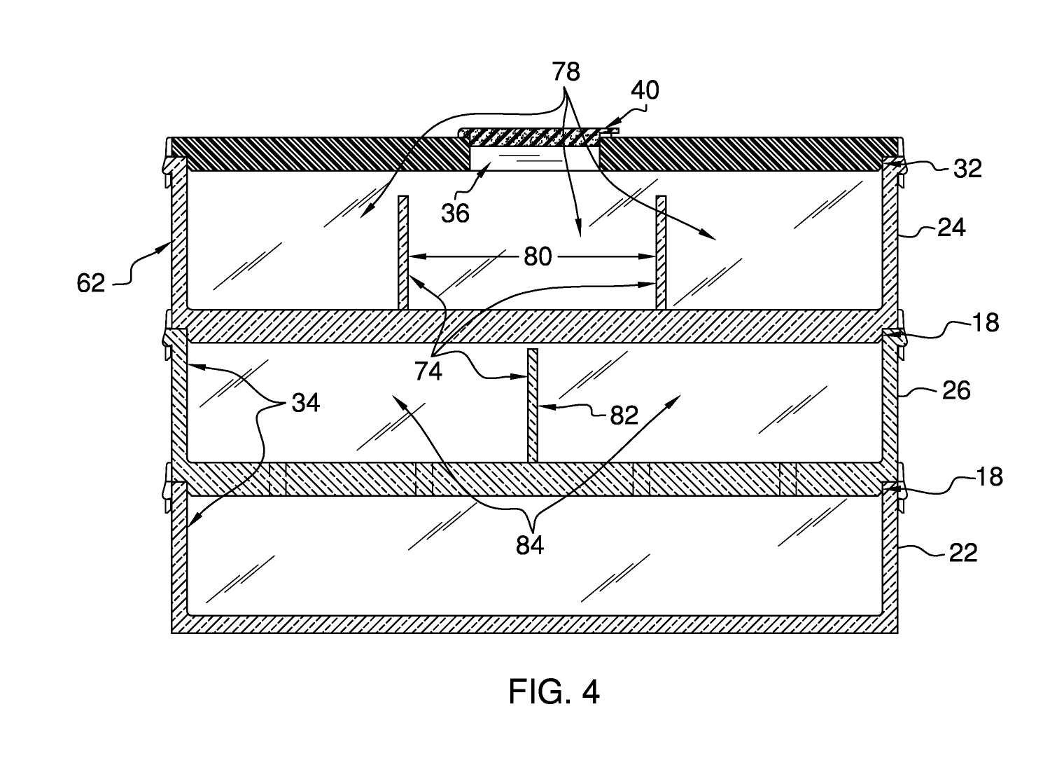

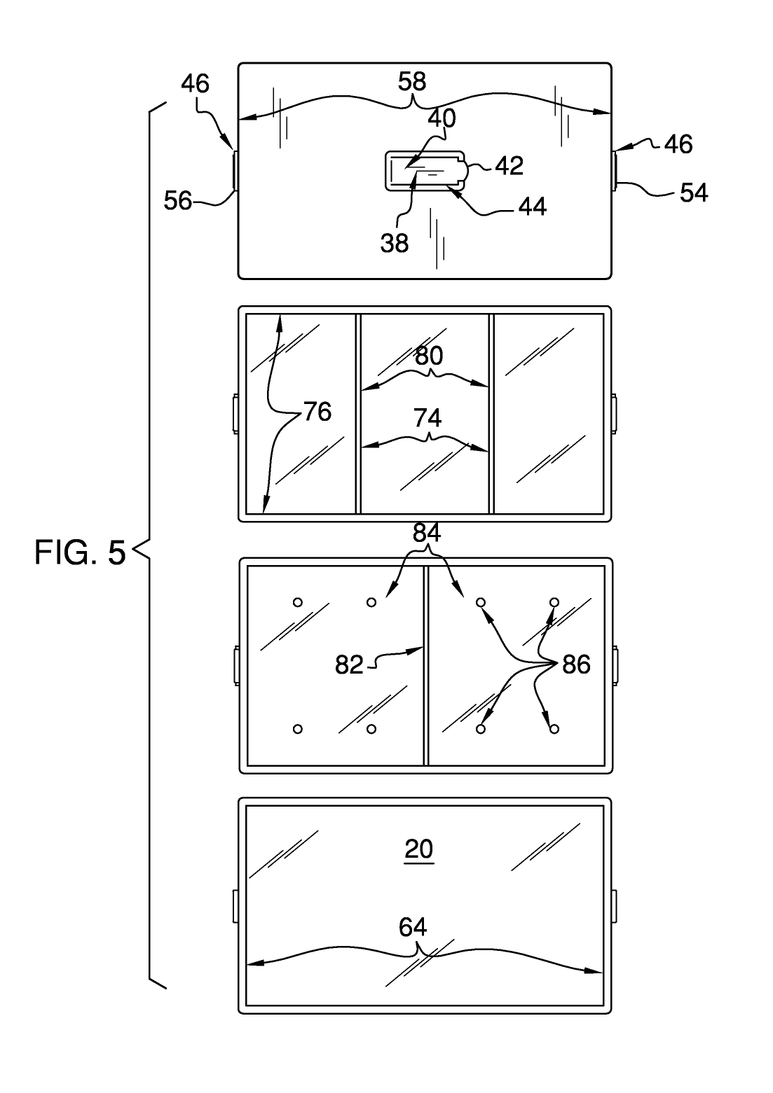

With reference now to the drawings, and in particular to FIGS. 1 through 5 thereof, a new container device embodying the principles and concepts of an embodiment of the disclosure and generally designated by the reference numeral 10 will be described.

As best illustrated in FIGS. 1 through 5, the compartmentalized food container device 10 generally comprises a plurality of bins 12 with each bin 12 having a bottom 14 and an open top 16. The bins 12 are boxed shaped and have indented edges 18, such that the bins 12 are stackable. Each bin 12 may have a rectangular base 20. The plurality of bins 12 comprises a lower bin 22, an upper bin 24, and a plurality of intermediate bins 26.

Preferably, the plurality of intermediate bins 26 comprises a middle bin 28. A lid 30 that is complimentary to the open top 16 has a recessed edge 32 that is in contact with an interior surface 34 of the upper bin 24 when the lid 30 is placed on the open top 16, such that the lid 30 is sealed the upper bin 24. A vent 36 is positioned in the lid 30, preferably in a center 38 of the lid 30. A seal 40 that is removable from the vent 36 comprises a pull 42 and a partial perforation 44, such that the seal 40 can be removed by pulling on the pull 42 and separating the seal 40 along the partial perforation 44 to expose the vent 36.

Each of a plurality of couplers 46 is coupled to a border 48 of the lid 30. The plurality of couplers 46 comprises extensions 50 that are flexible. Each of the extensions 50 has an orifice 52. Preferably, the plurality of couplers 46 comprises a first coupler 54 and a second coupler 56 positioned on a pair of opposing ends 58 of the lid 30.

Each of a plurality of first fasteners 60 is coupled to an outside surface 62 of the bins 12 proximate to the bottom 14. Preferably, one of each of the plurality of first fasteners 60 is coupled on a pair of opposing sides 64. More preferably, the plurality of first fasteners 60 is coupled to the upper bin 24 and the plurality of intermediate bins 26 and comprises clasps 66. The clasps 66 are flexible and each of the clasps has an opening 68.

A plurality of second fasteners 70, which is complimentary to the plurality of first fasteners 60 and the plurality of couplers 46, is coupled to the outside surface 62 proximate to the open top 16. Preferably, one of each of the plurality of second fasteners 70 is coupled on the pair of opposing sides 64, and the plurality of second fasteners 70 comprises locks 72. The locks 72 are complimentary to the openings 68 and the orifices 52, such that the second fasteners 70 are positioned both to engage the couplers 46 to secure the lid 30 to the bins 12, and to engage the first fasteners 60 to secure the bins 12 together.

Each of a plurality of dividers 74 is coupled to the bottom 14 and extends between an opposing pair of sidewalls 76, thus defining a plurality of compartments 78 within the bins 12. Preferably, each of the plurality of compartments 78 is equally sized and the plurality of dividers 74 comprises a pair of dividers 80 positioned in the upper bin 24. The pair of dividers 80 extends from the bottom 14 to proximate to the open top 16. The plurality of dividers 74 also may comprise a panel 82 in each of the plurality of intermediate bins 26, with each of the panels 82 defining a pair of chambers 84. The panels 82 extend from the bottom 14 to proximate to the open top 16. Each of the pair of chambers 84 is equally sized.

A plurality of holes 86 is positioned in the bottom 14 of the intermediate bins 26. Preferably, the plurality of holes 86 comprises four holes in each of the pair of chambers 84. The device 10 is microwavable and freezer compatible.

In use, the plurality of dividers 74 is positioned in the plurality of bins 12 allowing the user to place a variety of food articles into the plurality of bins 12 while maintaining separation of the food articles, such that the lid 30 can be engaged to the open top 16 and secured with the plurality of couplers 46 and the plurality of second fasteners 70, and the bins 12 can be secured together with the plurality of first fasteners 60 and the plurality of second fasteners 70, maintaining the food articles in a fresh state until the seal 40 is removed from the vent 36 prior to the device 10 and food articles being subjected to microwave heating.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

Amendments in the claims: (struck-through parts deleted and underlined parts added):

1. A compartmentalized food container device, said device comprising:
a plurality of bins, said bins having a bottom and an open top;
a lid, said lid being complimentary to said open top;
a vent, said vent being positioned in said lid;
a seal, said seal being removable from said vent;
a plurality of couplers, each of said plurality of couplers being coupled to a border of said lid;
a plurality of first fasteners, each of said plurality of first fasteners being coupled to an outside surface of said bin;
a plurality of second fasteners, said plurality of second fasteners being complimentary to said plurality of first fasteners and said plurality of couplers, each of said plurality of second fasteners being coupled to said outside surface;
a plurality of dividers, each of said plurality of dividers being coupled to said bottom and extending between an opposing pair of sidewalls;
a plurality of holes, said plurality of holes being positioned in said bottom of a plurality of intermediate bins; and
said device being microwavable.

2. The device of claim 1, further comprising:
said bins being boxed shaped; and
said bottoms having indented edges, wherein said bins are stackable.

3. The device of claim 1, further including said bins having a rectangular base

4. The device of claim 1, further including said plurality of bins comprising a lower bin, an upper bin, and a plurality of intermediate bins.

5. The device of claim 4, further including said plurality of intermediate bins comprising a middle bin.

6. The device of claim 1, further including said lid having a recessed edge, said recessed edge being in contact with an interior surface of said bin when said lid is placed on said open top, wherein said lid is sealed to said bin.

7. The device of claim 1, further including said vent being positioned in a center of said lid.

8. The device of claim 1, further including said seal comprising a pull and a partial perforation, wherein said seal can be removed by pulling on said pull and separating said seal along said partial perforation to expose said vent.

9. The device of claim 1, further comprising:
said plurality of couplers comprising extensions, said extensions being flexible, each of said extensions having an orifice;
said plurality of first fasteners being coupled to an outside surface of said bin proximate to said bottom, said plurality of first fasteners comprising clasps, said clasps being flexible, each of said clasps having an opening;
said plurality of second fasteners comprising locks, said locks being complimentary to said openings and said orifices, each of said plurality of second fasteners being coupled to said outside surface proximate to said open top; and
wherein said second fasteners are positioned both to engage said couplers to secure said lid to said bins and to engage said first fasteners and to secure said bins together.

10. The device of claim 9, further comprising:
said plurality of couplers comprising a first coupler and a second coupler, said first coupler and said second coupler being positioned on a pair of opposing ends of said lid;
one of each of said plurality of first fasteners being coupled on a pair of opposing sides, said plurality of first fasteners being coupled to said upper bin and said plurality of intermediate bins; and
one of each of said plurality of second fasteners being coupled on said pair of opposing sides.

11. The device of claim 1, further comprising:
said plurality of dividers defining a plurality of compartments within said bins; and
each of said plurality of compartments being equally sized.

12. The device of claim 11, further comprising:
said plurality of dividers comprising a pair of dividers positioned in said upper bin; and
said pair of dividers extending from said bottom to proximate to said open top.

13. The device of claim 1, further comprising:
said plurality of dividers comprising a panel in each of said plurality of intermediate bins, each of said panels defining a pair of chambers; and
said panels extending from said bottom to proximate to said open top.

14. The device of claim 13, further including said pair of chambers being equally sized.

15. The device of claim 13, further including said plurality of holes comprising four holes in each said pair of chambers.

16. A compartmentalized food container device, said device comprising:
a plurality of bins, said bins having a bottom and an open top, said bins being boxed shaped, said bottoms having indented edges, wherein said bins are stackable, said bins having a rectangular base, said plurality of bins comprising a lower bin, an upper bin, and a plurality of intermediate bins, said plurality of intermediate bins comprising a middle bin;
a lid, said lid being complimentary to said open top, said lid having a recessed edge, said recessed edge being in contact with an interior surface of said bin when said lid is placed on said open top, wherein said lid is sealed to said bin;
a vent, said vent being positioned in said lid, said vent being positioned in a center of said lid;
a seal, said seal being removable from said vent, said seal comprising a pull and a partial perforation, wherein said seal can be removed by pulling on said pull and separating said seal along said partial perforation to expose said vent;
a plurality of couplers, each of said plurality of couplers being coupled to a border of said lid, said plurality of couplers comprising extensions, said extensions being flexible, each of said extensions having an orifice, said plurality of couplers comprising a first coupler and a second coupler, said first coupler and said second coupler being positioned on a pair of opposing ends of said lid;
a plurality of first fasteners, each of said plurality of first fasteners being coupled to an outside surface of said bin proximate to said bottom, one of each of said plurality of first fasteners being coupled on a pair of opposing sides, said plurality of first fasteners being coupled to said upper bin and said plurality of intermediate bins, said plurality of first fasteners comprising clasps, said clasps being flexible, each of said clasps having an opening;
a plurality of second fasteners, said plurality of second fasteners being complimentary to said plurality of first fasteners and said plurality of couplers, each of said plurality of second fasteners being coupled to said outside surface proximate to said open top, one of each of said plurality of second fasteners being coupled on said pair of opposing sides, said plurality of second fasteners comprising locks, said locks being complimentary to said openings and said orifices, wherein said second fasteners are positioned both to engage said couplers to secure said lid to said bins and to engage said first fasteners and to secure said bins together;
a plurality of dividers, each of said plurality of dividers being coupled to said bottom and extending between an opposing pair of sidewalls defining a plurality of compartments within said bins, each of said plurality of compartments being equally sized, said plurality of dividers comprising a pair of dividers positioned in said upper bin, said pair of dividers extending from said bottom to proximate to said open top, said plurality of dividers comprising a panel in each of said plurality of intermediate bins. each said panel defining a pair of chambers, said panels extending from said bottom to proximate to said open top, said pair of chambers being equally sized;
a plurality of holes, said plurality of holes being positioned in said bottom of said intermediate bins, said plurality of holes comprising four holes in each said pair of chambers;
said device being microwavable;
said device being freezer compatible; and
wherein said plurality of dividers are positioned in said plurality of bins allowing the user to place a variety of food articles into said plurality of bins while maintaining separation of the food articles, such that said lid can be engaged to said open top and secured with said plurality of couplers and said plurality of second fasteners, and said bins can be secured together with said plurality of first fasteners and said plurality of second fasteners, maintaining the food articles in a fresh state until said seal is removed from said vent prior to said device and food articles being subjected to microwave heating.
